(19) United States
(12) Patent Application Publication
(10) Pub. No.: US 2026/0255043 A1
(43) Pub. Date: Aug. 27, 2026

(54) PLANT ROOT IMAGING SYSTEM

(71) Applicant: Sparkform Technologies Inc., Windsor (CA)

(72) Inventors: Calvin LOVE, Windsor (CA); Cameron PROCTOR, Tecumesh (CA); Matt McREYNOLDS, Tecumesh (CA); Adam TURTON, Windsor (CA)

(21) Appl. No.: 19/453,315

(22) Filed: Jan. 20, 2026

Related U.S. Application Data
(60) Provisional application No. 63/746,831, filed on Jan. 17, 2025.

(51) Int. Cl. H04N 23/50; H04N 23/51; H04N 23/56; H04N 23/65; H04N 23/74

(52) U.S. Cl. CPC H04N 23/555; H04N 23/51; H04N 23/56; H04N 23/65; H04N 23/74

(57) ABSTRACT

An imaging system for generating images of plant roots below ground surface is disclosed. An imager is disposed upon a circuit board that defines an elongated configuration. The imager takes the form of a camera or plurality of cameras for generating an image of the plant roots while the imaging system is disposed below ground surface. An illumination system electronically connected upon said circuit board for illuminating the plant roots being imaged by the imager. The illumination system takes the form of a plurality of light emitting diodes dispersed around the imager. The circuit board, the imager, and the illumination system are encapsulated in a polymeric overmolding that seals each of the circuit board, the imager, and the illumination system from environmental contaminants when the imaging system is disposed below ground surface

### REFERENCE TO RELATED APPLICATIONS

The present application claims priority to United States Provisional Patent Application No. 63/746,831 filed on January 17, 2025, the contents of which are included in its entirety.

### TECHNICAL FIELD

The present application relates generally toward an imaging system for generating images of plant roots. More specifically, the present invention relates to an improved minirhizotron.

### BACKGROUND

Taking into consideration the development of plant root systems, a significant engineering challenge is presented. The soil wherein the root systems grow is of course opaque and thus restricts the passage of light. Monitoring the health of root systems within their intended growing environment is a goal shared by researchers and end-users alike. While some devices restrict root growth to a fixed container, others permit the execution of root inspection in their somewhat natural, open-air farming environment. These root phenotyping devices, seemingly favored by researchers are minirhizotrons that consist of a transparent tube or similar elongated enclosure that is buried in proximity to the plant root specimen. Contained within a typical minirhizotron is a single camera module that is actuated (or actuated and rotated) along the length of a clear tube or elongated enclosure. or scans of the tube exterior, and post capture are stitched together to form an image

The camera location within the minirhizotron is manipulated either by a motorized actuator or through manual intervention by an operator. For many minirhizotron systems which require manual operation, an operator must connect to the system via laptop or other electronic device and push or rotate the camera lens down the length of the minirhizotron while taking images of the root system. This approach greatly reduces the number of samples that can be taken as a commercial open-air farm spans hundreds to thousands of acres. Alternatively, a minirhizotron that integrates a motor driven actuator allows for the installation of hundreds of minirhizotron which can be distributed throughout the open-air farming environment. However, these motorized systems contain several moving parts that are prone to failure upon exposure to temperature variations, moisture, and other ground level contaminants that often result in general mechanical fatigue.

However, seals are often prone to failure due to extreme weather conditions allowing condensation to form on interior tube walls, particularly below ground. Thus, implementing a motor actuated minirhizotron along with necessary power provides very limited lifespans requiring periodic repairs and replacement and charging associated batteries. Alternatively, the implementation of high energy solar panels may be electrically connected to charge the batteries. This approach is not financially feasible when large areas are involved and reduces the number of minirhizotrons that may be implemented simultaneously.

Therefore, a need exists for large scale monitoring of plant root systems providing in-situ, below ground inspection that is cost efficient, consumes limited amounts of energy and provides limited complexity to reduce repair requirements.

### SUMMARY

An imaging system for generating images of plant roots below ground surface is disclosed. An imager is disposed upon a circuit board that defines an elongated configuration. The imager takes the form of a camera or plurality of cameras for generating an image of the plant roots while the imaging system is disposed below ground surface. An illumination system electronically connected upon said circuit board for illuminating the plant roots being imaged by the imager. The illumination system takes the form of a plurality of light emitting diodes dispersed around the imager. The circuit board, the imager, and the illumination system are encapsulated in a polymeric overmolding that seals each of the circuit board, the imager, and the illumination system from environmental contaminants when the imaging system is disposed below ground surface.

The novel approach of sealing, and more precisely overmolding all of the components necessary to provide a functioning minirhizotron solved all of the problems associated with prior art minirhizotron. A low-cost imaging system that includes a plurality of cameras that are properly illuminated by light emitting diodes, and the like, eliminates the need for manual or mechanical movement commonly utilized and even required for conventional minirhizotrons. Furthermore, full encapsulation of all of the items required to generate images of plant root systems achieved by overmolding the entire system prevents any environmental contaminants from accessing any of the internal components. Therefore, the system is devoid of moisture even when disposed below ground level in moist dirt providing for a longer lifespan of the system and improved performance.

### BRIEF DESCRIPTION OF FIGURES

Other advantages of the present invention will be readily appreciated as the same becomes better understood by reference to the following detailed description, when considered in connection with the accompanying drawing, wherein:

FIG. 1 shows a perspective view of the plant root imaging system of the present invention;

FIG. 2 shows a plan view of the plant root imaging system of the present invention;

FIG. 3 shows a side view of the plant root imaging system of the present invention;

FIG. 4 shows an end view of the plant root imaging system of the present invention;

FIG. 5 shows a partial plan view of the plant root imaging system of the present invention;

FIG. 6 shows a bottom view the circuit board with the rechargeable batteries in view;

FIG. 7 shows an exploded view of a camera assembly; and

FIG. 8 shows a perspective view of the imaging system with the overmolding drawn in phantom.

### DETAILED DESCRIPTION

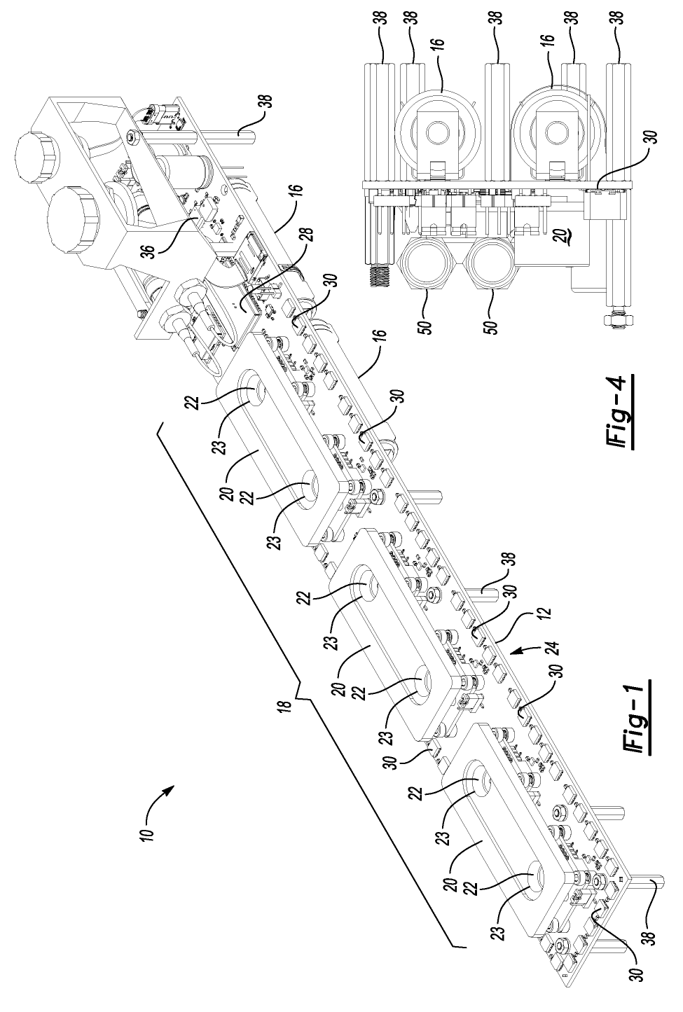

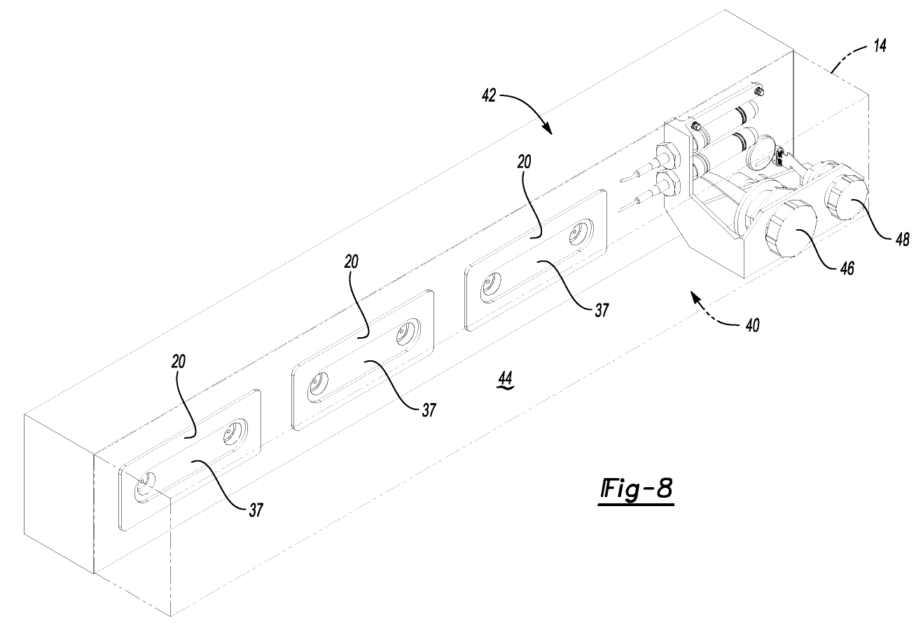

Referring to FIG. 1, a schematic view of a root imaging system of the present invention is generally shown at 10. The imaging system 10 includes a circuit board 12 that is disposed within an overmolding 14 (best seen in FIG. 8). In an alternative embodiment, a plurality of circuit boards 12 is implemented and electronically interconnected with various components used to operate the imaging system 10. A power module 16 takes the form of a rechargeable battery is electrically connected to the circuit board 12 for providing electrical power to the circuit board 12 as will be explained further hereinbelow. A plurality of power modules 16 may also be included to increase longevity between charging cycles.

An imager 18 is disposed upon the circuit board 12. In one embodiment, the imager 18 takes the form of a plurality of camera assemblies 20. Each camera assembly 20 includes one or more image sensors 22, either CCD, CMOS, or equivalent sensors 22 and a corresponding lens 23 together forming a complete camera. Each lens 23 is adjustable for providing an adjustable focus to the sensors 22 as will be explained further hereinbelow. In the embodiment best shown in FIGS. 1, and 3-5, each camera assembly 20 includes two sensors 22. Each sensor 22 is provided a field of view that overlaps with each adjacent sensor 22 so that a composite image may be generated of a root system as will also be explained further hereinbelow. As is known to those of skill in the art, the CMOS sensor provides more energy efficiency, and the CCD sensor provides higher resolution. Selection of the image sensor 22 is based upon particular purpose.

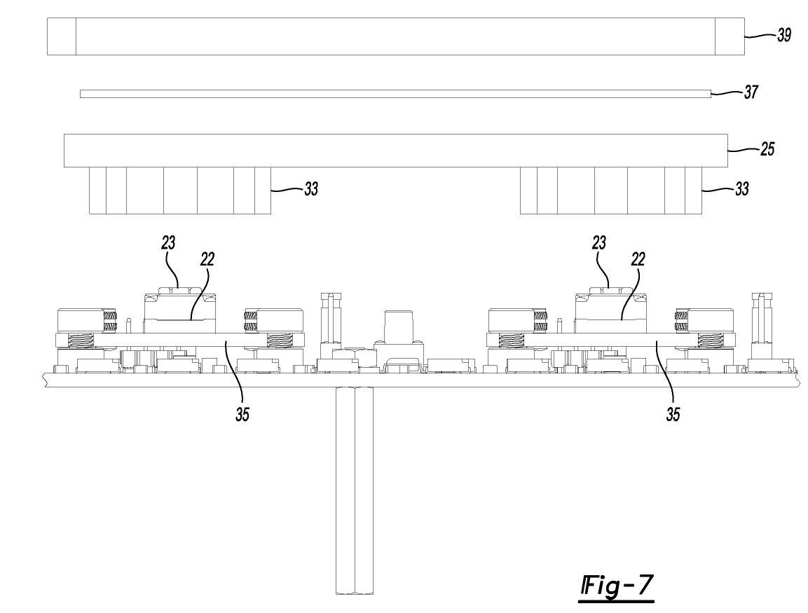

As best represented in the exploded view shown in FIG. 7, each camera assembly 20 is adapted to protect the image sensors 22 and lens 23 during application of the overmolding 14. The camera assembly 20 includes a lower housing member 25. The lower housing 25 defines a protective element 33 that seals around the image sensor 22 and lens 23 by abutting a sensor base 35. A transparent element 37 is sandwiched between the lower housing member 25 and an upper housing member 39 to form a protective enclosure for the image sensors 22. The upper housing member 39 defines an opening 41 that forms an outline of a window enclosed by the transparent element 37. In one embodiment, the transparent element 37 takes the form of flat glass that does not affect the optics of the image sensor 22. Although the Figures show two images sensors 22 disposed with a single protective enclosure, it should be understood by those of skill in the art than two or more image sensors 22 may be disposed with a single protective enclosure.

An illumination system 24 is also affixed to the circuit board 12 for illuminating the plant roots that are photographed by the imager 18. The overmolding 14 fully encapsulates the circuit board 12, the imaging array 18 and the illumination system 24. In one embodiment, the power module 16 is also encapsulated within the overmolding 14 and is powered through electromagnetic induction or conventionally through accessible electrical connection by way of a USB port 26 or equivalent. In addition, a flash storage port 27 is optionally included to access images stored on the controller 28 or other memory device affixed to the circuit board 12. In an alternative embodiment, the power module 16 is replaceable when electrical charging is necessary. It will become readily apparent that the system 10 does not require frequent charging due to the energy efficient principles adopted by the inventors. A single charge may last for several months so that the assembly 10 may be placed in the ground to generate images of plant roots for an entire growing season.

In an alternative embodiment, a plurality of circuit boards 12 may be encapsulated within the overmolding 14 and any of the plurality of circuit boards 12 may include an imager 18 and an illumination system 18. Each of the plurality of circuit boards 12 may be electronically interconnected or may operate independently of or collaboratively with the other of the circuit boards 12.

Each of the cameras 20 are electronically connected to a controller 28 via electronic circuit disposed upon the circuit board 12 in a known manner. As such, it should be understood that each camera 20 includes a camera communication hub 29 that facilitates communication between its respective camera 20 and the controller 28. In one embodiment, each sensor 22 is electronically connected to the connector 28. The controller 28 initiates imaging sequences and receives the pixilated images generated by each of the cameras 20. The cameras 20 remain stationary during an imaging sequence. Furthermore, the entire system 10, once inserted into the ground and positioned for providing visible access to the plant roots remains in the ground and stationary unless removed for service or for charging the power module 16 when necessary.

The cameras 20 are arranged in a one-dimensional orientation so that an axis defined by each lens 24 parallel to all the other lenses 24, i.e. the cameras 24 are each unidirectional. Alternatively, a two-dimensional orientation of the cameras 20 in which the axis of each lens 24, are divergent relative to the width W of the circuit board 12 is implemented to provide a wider view angle of the plant roots.

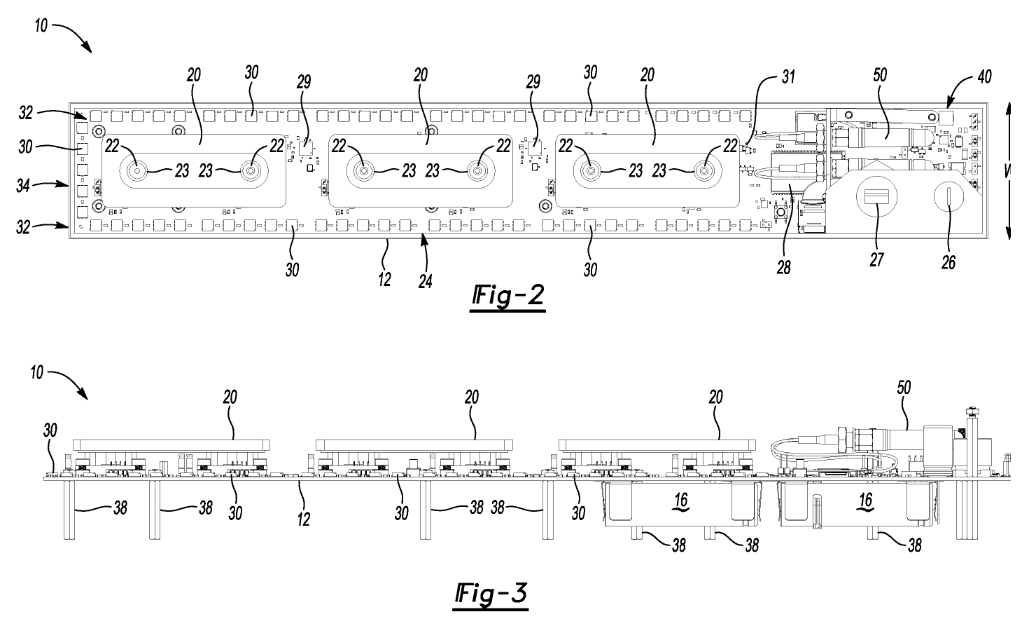

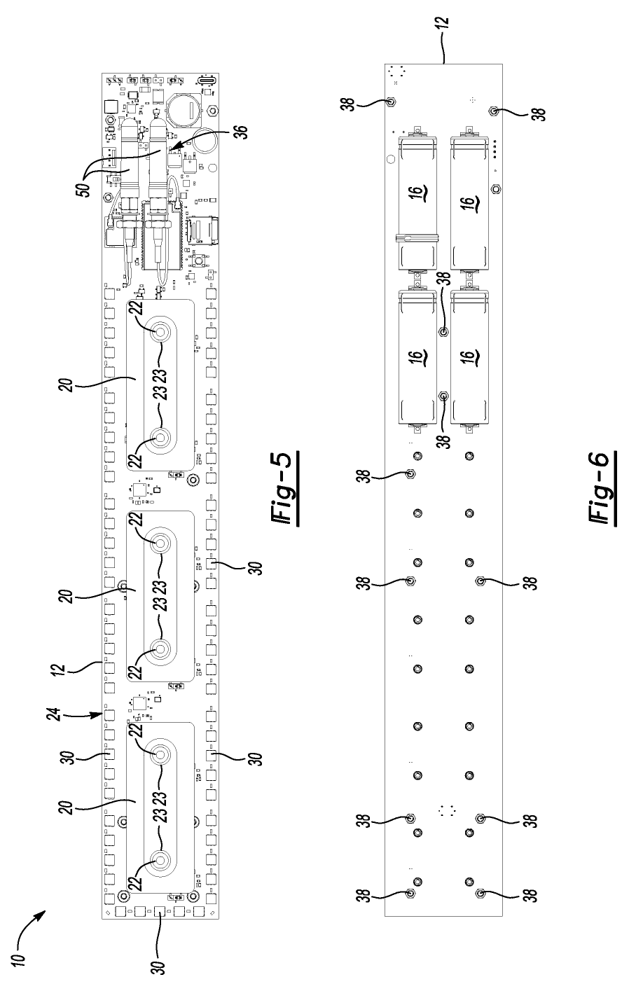

As set forth above, the illumination system 24 illuminates the plant roots while the cameras 20 are generating an image. The illumination system 24 includes a plurality of light emitting diodes (LED’s) 30. The LED’s 30 are arranged in opposing rows 32 extending lengthwise of the circuit board 12 on opposites sides of the cameras 20 as best seen in FIG. 2 and FIG. 5. In one embodiment, the LED’s 30 are grouped adjacent to each camera 22 so that at least two series of five LED’s 30 are located on opposing sides of each camera 24. A connecting row 34 of LED’s 30 extend between the opposing rows 32 of LED’s 30 at a distal end of the opposing rows 32. However, alternative arrangements of the LED’s 30 to suit a particular purpose is also within the scope of this invention including locating a connecting row 34 of LED’s 30 between adjacent cameras 20.

The controller 28 is electronically connected to each LED 30 using electronic circuits on the circuit board 12 in a known manner. As such, it should be understood by those of ordinary skill in the art that the LED’s 30 communicate with the controller 28 via a LED communication element 31. The controller 28 synchronizes a programable sequence of single or multiple flashes of a LED 30, multiple LED’s 30, or all LED’s 30 with the image capture sequence of the cameras 20. Alternatively, the LED’s 30 remain illuminated during a sequence of images generated by the cameras 20. The illumination time of the LED’s 30 is limited by the controller 28 to only necessary image capture sequences to reduce unnecessary drain of energy from the power module 16.

A clock 36 is affixed to the circuit board 12 and is electronically connected to the controller 28. The clock 36 maintains real time determination for the controller 28 to provide time-controlled image sequences. Thus, the images generated by the cameras 20 may be timed by the clock 36 and initiated by the controller 28. The clock 36 continuously tracks passage of time and keeps current time in a clock memory element. Current time is signaled to a time switch that activates the controller 28 to initiate an image sequence at predetermined intervals as programmed to the clock memory element. In one embodiment, the clock 36 is powered by an independent power source separate from the power module 16.

It should be understood that an ad hoc image may also be generated when desired regardless of the predetermined timed imaging. For example, after an adverse weather event or other event, a remote operator may manually trigger an image sequence by transmitting a wireless signal to the system 10. Thus, an operator may initiate the ad hoc image sequence at any time based upon the operator’s desire for additional imaging. Alternatively, environmental sensors could trigger an ad hoc image sequence based upon the adverse weather event. The sensors are contemplated to trigger the ad hoc image sequence when a weather event is within a range or has reached a threshold as determined by the controller 28. This includes water sensors identifying the soil has reached a threshold moisture level or if temperature sensors have identified a hot or cold temperature threshold has been reached.

The clock 36, via the controller 28, also triggers illumination by the LED’s 30 at timed sequences. In one embodiment, as needed by the imaging sequence, each LED 30 may be powered individually to generate illumination. Thus, illumination by any of the LED’s 30 may be individually indexed and each LED 30 is powered or depowered individually. Frequency of illumination of any LED 30 is varied independently by the controller 28 to illuminate roots for any of the cameras 20. Further, illumination intensity of any of the LED’s 30 is adjustable and also varied independently by the controller 28 to achieve optimal illumination of the roots being photographed.

As set forth above and shown best in FIG. 8, the overmolding 14 completely encases the circuit board 12 and all of the interconnected components. In one embodiment, the overmolding 14 is formed from a clear epoxy. Where necessary to improve image quality a frosted resin diffuser may also be implemented to diffuse light emitted from the LED’s 30. Alternative clear resins including but not limited to acrylic are also within the scope of this invention. Any polymeric resin that prevents penetration of environmental penetration is within the scope of this invention.

After assembly, the circuit board 12 is placed within a resin mold or other equivalent mold into which the resin is poured and cured to form the overmolding 14. In one embodiment, a plurality of studs 38 are fixedly attached to the circuit board 12 on an opposite side of from the cameras 20. The studs 38 space the circuit board 12 from walls defining a mold cavity in which the polymer is poured to form the overmolding 14 to assist complete encapsulation of the system 10 and to position the circuit board 12 where desired within the mold cavity. The resin used to form the overmolding 14 should not include a liquification temperature that is beyond the thermal resistance of any of the electronic components that make up the system 10.

In one embodiment, the overmolding 14 includes a first overmolding element 40 and a second overmolding element 42. The first overmolding element 40 is contemplated by the inventors to be clear to encapsulate the camera assemblies 20 enabling a clear view of the sensors 22 to the plant roots. In this embodiment, the second overmolding element 42 is disposed on an opposite side of the circuit board 12 from the cameras 20. The second overmolding element 42 is formed from a resin that cures in a frosted or translucent disposition and covers the LED’s 30 to diffuse light generated by the LED’s 30 for avoiding unwanted reflective glare when generating the images. In an alternative embodiment, the second overmolding element 42 monolithic with the first overmolding element 40 and is subject to a dip coating or equivalent to provide an opaque protective cover over the second overmolding element 42. It may be beneficial for the second overmolding element 42 to cure prior to applying the first overmolding element 40. The resin used to form the second overmolding element 42 fills the mold to a level that matches the height of the upper housing member 39 but does not cover the transparent element 37 exposed by the opening 41 defined by the upper housing member 39. Only the transparent first overmolding element 40 covers the transparent element 37 so that the view of the image sensors 22 is not obscured.

Thus, the circuit board 12 and all of the interconnected components are completely protected from environmental damage, such as, for example, water, ice, and thermal variability. The USB port 26 and the flash storage port 27 are protected from the resin used to form the overmolding 14 by masking or other conventional shielding method during the molding process. Any variety of molding processes may be implemented to form the overmolding 14 each of which are within the scope of this invention. The USB port 26 and flash storage port 27 or equivalent connection is included for data transfer and power management for the power module 16 in a conventional manner as should be understood by those of ordinary skill in the art. The USB port 26 and the flash storage port 27 extend through the overmolding 14 to provide electronic access to the system 10 in a known manner when the system, or at least the ports 26, 27 are exposed above the ground surface. A first cap 46 and a second cap 48 are used to cover the ports 26, 27 respectively when access to the ports 26, 27 is not needed.

The material selected to form the overmolding 14, and more specifically the first overmolding element 40 is desirably beneficial to the camera 20 optics. Thus, transparency without distortion is an imperative for the generation of high-resolution images of the plant roots. Infusion of mineral oil or other fillers into the material used to form the overmolding 14 to reduce distortion, improve optics and reduce glare from illumination by the LED’s is also within the scope of this invention and believed to enhance optics.

The dimensions and configuration of the overmolding 14, and more precisely the first overmolding element 42, is also designed to enhance optics and reduce distortion, or at least not adversely affect quality of the images generated by the cameras 20. The overmolding 14 spaces the camera lens 24 from the plant roots being imaged. As shown in FIG. 8 the overmolding 14 presents a planar surface 40 that is spaced from the camera lenses 24. The planar surface 44 is configured and located to prevent distortion of the images captured by each of the cameras 20. Alternatively, the planar surface 44 is slightly arcuate to magnify or otherwise revise the camera 20 optics to enhance image quality. However, it should be understood that optical precision of the generated images is enhanced by moving the lens 23 along the optical axis, a motion that may be performed remotely by an operator via wireless transmission or via USB port.

In an alternative embodiment, images generated by the cameras 20 and signaled to the controller 28 are transmitted by a transmitting device 50 best shown in FIGS. 2-5 to a remote processor or stored on a removable storage device. In one embodiment, the transmitting device 50 is a Wi-Fi connector and antenna. Thus, the transmitting device 50 transmits signals to a remote process that may take the form of a smart device, laptop computer or remote hard drive. The antenna that comprises the transmitting device 50 is an RF antenna (LORA or otherwise) configured to transmit or receive data or wake signal long distances up to one kilometer or further when necessary. The transmission may be any of radio frequency, Bluetooth, Wi-Fi, or hard wire. Each image is defined by pixels of the imaged plant roots.

Because the images are generated by individual cameras, an individual image may not provide sufficient information about plant root status. Therefore, the processor generates a composite image by integrating the individual camera images, the composite of which provides a full scope of the plant root status. In an alternative embodiment, the controller 28 generates the composite image and the composite image is transferred to the remote processor either via the ports 46, 48 or the transmitting device 50. When appropriately oriented, the composite image may be a two-dimensional or three-dimensional composite image. Further to this point, several images may be taken and composited from a single camera using different lighting methods to render a high-quality image.

The invention has been described is in an illustrative manner; many modifications and variations of the present invention are possible in light of the above teachings. It is therefore to be understood that within the specification, the reference numerals are merely for convenience, and are not to be in any way limiting, and that the invention may be practiced otherwise than is specifically described. Therefore, the invention can be practiced otherwise than is specifically described within the scope of the stated claims following this first disclosed embodiment.

The system set forth in claim 2, wherein each of said plurality of cameras comprise an image sensor being one of a CMOS or a CCD sensor.

The system set forth in claim 15, wherein said rechargeable battery is rechargeable through said USB port.

The system set forth in in claim 2, wherein each of said imagers includes a focal lens being cooperable with each of said cameras, said lens being movable along a focal axis defined by each camera for focusing an image generated by said cameras.

What is claimed is:

1. An imaging system for generating images of plant roots below ground surface, comprising:
a circuit board defining an elongated configuration;
an imager disposed upon said circuit board for generating an image of the plant roots;
an illumination system disposed upon said circuit board for illuminating the plant roots being imaged by the imager; and
said circuit board, said imager, and said illumination system being encapsulated in a polymeric overmolding thereby sealing said circuit board, said imager, and said illumination system from environmental contaminants when said imaging system is disposed below ground surface.

2. The system set forth in claim 1, wherein imager comprises a plurality of cameras being spaced along said circuit board.

3. The system set forth in claim 2, wherein each of said plurality of cameras comprise an image sensor being one of a CMOS or a CCD sensor.

4. The system set forth in claim 3, wherein said sensors are each spaced above said circuit board.

5. The system set forth in claim 1, wherein said illumination system comprises a plurality of light emitting diodes (LED’s) dispersed along said circuit board.

6. The system set forth in claim 5, wherein said LED’s are arranged in opposing rows on opposite sides of said imager.

7. The system set forth in claim 5, wherein said LED’s substantially circumscribe said imager.

8. The system set forth in claim 1, wherein said circuit board includes a controller being electronically connected to said imager and said illumination system for controlling imaging and illumination sequence(s) of the imager and the illumination system.

9. The system set forth in claim 8, wherein said circuit board includes a clock for signaling said controller to initiate timed imaging and illumination sequence(s).

10. The system set forth in claim 1, wherein said overmolding defines a planar surface being cooperable with said imager for generating high resolution images of the roots dispose below ground surface.

11. The system set forth in claim 10, wherein said planar surface is cooperable with an image plane defined by said imager.

12. The system set forth in in claim 1, wherein said imager includes a plurality of images sensors each of which signal an image to said controller for generating a composite image of the roots disposed below ground surface.

13. The system set forth in claim 1, wherein said imager is signaled by a controller to generate ad hoc images.

14. The system set forth in claim 1, wherein at least one of a flash storage port and a USB port extend through said overmolding for providing electronic access to said controller.

15. The system set forth in claim 1, further including a rechargeable battery being affixed to said circuit board for providing electrical energy to said system.

16. The system set forth in claim 15, wherein said rechargeable battery is rechargeable through said USB port.

17. The system set forth in in claim 2, wherein each of said imagers includes a focal lens being cooperable with each of said cameras, said lens being movable along a focal axis defined by each camera for focusing an image generated by said cameras.
